(19) United States
(12) Patent Application Publication
(10) Pub. No.: US 2003/0159523 A1
(43) Pub. Date: Aug. 28, 2003

(54) Contraband detection system

(76) Inventor: William Leonard Renfro, Washington, DC (US)

Correspondence Address: William L. Renfro, 1431 Thirty Third St NW, Georgetown, Washington, DC, 20007, US

(21) Appl. No.: 10/281,991

(22) Filed: Oct. 29, 2002

Related U.S. Application Data
(60) Provisional application No. 60/330,678, filed on Oct. 29, 2001.

(51) Int. Cl. G01N 1/00

(52) U.S. Cl. 73/863; 73/19.01; 436/161; 436/155; 340/540

(57) ABSTRACT

The preferred embodiment uses a chamber which is sized no larger than necessary to hold the particular type, size and shape of the baggage or cargo or containers being examined. This chamber has doors or openings sufficient to allow the easy entry and exit of objects being examined. These doors or openings are easily and quickly moved back and forth, making and breaking a vacuum seal which will withstand internal depressurization to the equivalent of an altitude of 12,000 feet above sea level. For the examination of individuals and items not in the container, a flexible tube is attached to vacuum pump. This flexible tube has a short stiff pipe on the end which is used to probe into areas to collect vapors which are then examined by the detector. The tube from the chamber feeds the air collected in the chamber to the vacuum pump which passes the collected air to the detector. The detector includes gas chromatographs, ion mobility spectroscopy, mass spectrometers or other detectors which have the ability to detect and identify elements, chemicals and compounds at the trace levels as low the nano-pico-femto-gram level or the level on one part-per-billion—trillion—PPB/PPT. The detector provides an alarm if specific pre-set elements, chemical or compounds are identified in the air collected in the chamber or in the flexible tube.

### BACKGROUND OF THE INVENTION

A variety of technical means can be used to detect the presence of elements, chemicals and compounds which are ingredients of explosives and of contraband drugs.. These include X-ray machines, sniffing machines, nuclear particle scattering, nuclear resonance machines, among others. Each technology has its strengths and weaknesses.

X-ray machines have difficulty in detecting the actual elements, chemicals and compounds which are ingredients of contraband drugs and of explosives themselves. Hence, X-ray detection has to rely on the size, shape and wrapping in the case of drugs. In the case of explosives, since the volume of modern explosives suitable for bombs such as RDX, PETN and other components used in C4, PE4, SX2, Semtex, Demex, Detasheet, etc., can be very small and do not have a distinct X-ray signatures, X-ray detectors have to rely on identifying components of the timing and detonating devices which accompany the explosives. Even more sophisticated detectors such as nuclear particle scattering, nuclear resonance machines have difficulty detecting small, dispersed or flattened explosive materials. The components of timing and detonating devices are almost impossible to detect if they do not appear together or in close proximity to each other.

Sniffing machines produce many false returns and can be defeated by careful handling and packaging of the contraband.

Nuclear particle scattering machines detect the unique scattering and/or absorption characteristics of each element. Elements such as nitrogen, while abundant and omnipresent as 20% of our air, appear in far greater concentrations as an ingredient in virtually all explosives. These greater concentrations produce unique scattering, absorption and resonance signatures for nuclear particles of particular energy levels. Detectors using nuclear characteristics are bulky, expensive, complex and require special handling and training.

Fortunately, when all existing technologies are used together, detection capabilities can reach high levels of reliability and confidence, making detection of contraband elements, chemicals and compounds which are ingredients of contraband drugs and of explosives almost certain. Unfortunately, they have not been used together and often are not used at all on most hand luggage, baggage and cargo on flights originating in or destined for the US.

### SUMMARY OF THE INVENTION

Trace levels of any contraband can be detected by detectors such as gas chromatographs, ion mobility spectroscopy, mass spectrometers or other detectors which have the ability to detect and identify elements, chemicals and compounds at the nano-pico-femto-gram level or the level on one part-per-billion—trillion—PPB/PPT. Such detectors can be and are defeated or reduced in effectiveness by sealed or wrapped air tight materials. Smuggled drugs and explosives attempt to avoid detection by air sampling detectors by being wrapped in sufficient layers of plastic or glassine bags.

In the present invention, contraband elements, chemicals and compounds which are ingredients of contraband drugs and of explosives are detected in a two stage process that cannot be defeated by wrapping and air tight sealing materials. By placing the baggage or cargo in a chamber that is then sealed and the internal pressure reduced by a vacuum pump to the equivalent of 12,000 feet of altitude (which the baggage or cargo will experience on a normal commercial flight inside the passenger cabin), gases including trace elements from sealed packages will be drawn from the interior of the baggage or cargo. The gases withdrawn from the chamber and the interior of the baggage or cargo are passed from the vacuum pump to a detector such as gas chromatographs, ion mobility spectroscopy, mass spectrometers or other detectors which have the ability to detect and identify quickly elements, chemicals and compounds at the nano-pico-femto-gram level or the level on one part-per-billion—trillion—PPB/PPT. An explosive in a container hidden in baggage or cargo that could withstand the decrease in pressure without releasing any internal gases would have to be of sufficient strength, size and mass that the container itself would easily be detectable by current x-ray technology.

The detector is programmed to detect particular elements, chemicals and compounds, making this invention useful for both explosive and drug detection as well as other, more exotic contraband which may be identified in the future.

### BRIEF DESCRIPTION OF THE DRAWINGS

In the figures:

FIG. 1 shows a Detector For Carry-on Baggage with a conveyor similar to those used for detectors now in use. FIG. 2 shows a Detector large enough to hold Baggage and Cargo.

### DETAILED DESCRIPTION OF THE INVENTION

The preferred embodiment uses a chamber which is sized no larger than necessary to hold the particular type, size and shape of the baggage or cargo or containers being examined. This chamber has doors or openings sufficient to allow the easy entry and exit of objects being examined. These doors or openings are easily and quickly moved back and forth, making and breaking a vacuum seal which will withstand internal depressurization to the equivalent of an altitude of 12,000 feet above sea level. For the examination of individuals and items not in the container, a flexible tube is attached to a vacuum pump. This flexible tube has a short stiff pipe on the end which is used to probe into areas to collect vapors which are then examined by the detector. The tube from the chamber feeds the air collected in the chamber to a vacuum pump which passes the collected air to the detector. The detector includes gas chromatography and mass spectrometry to analyze the collected air. The detector provides an alarm if specific pre-set elements, chemicals or compounds are identified in the air collected in the chamber or in the flexible tube.

### OVERVIEW AND CONSTRUCTION OF THE INVENTION

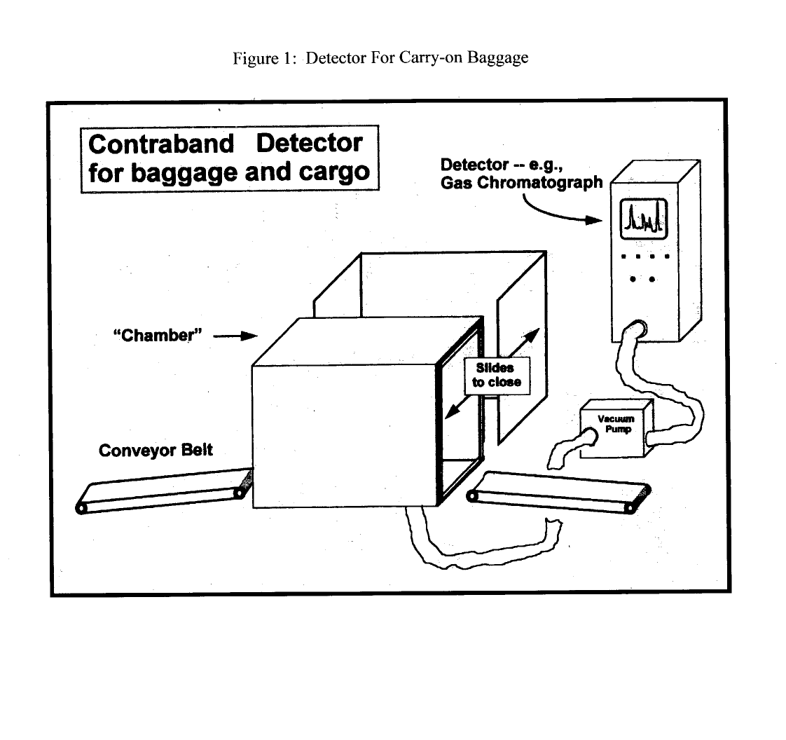

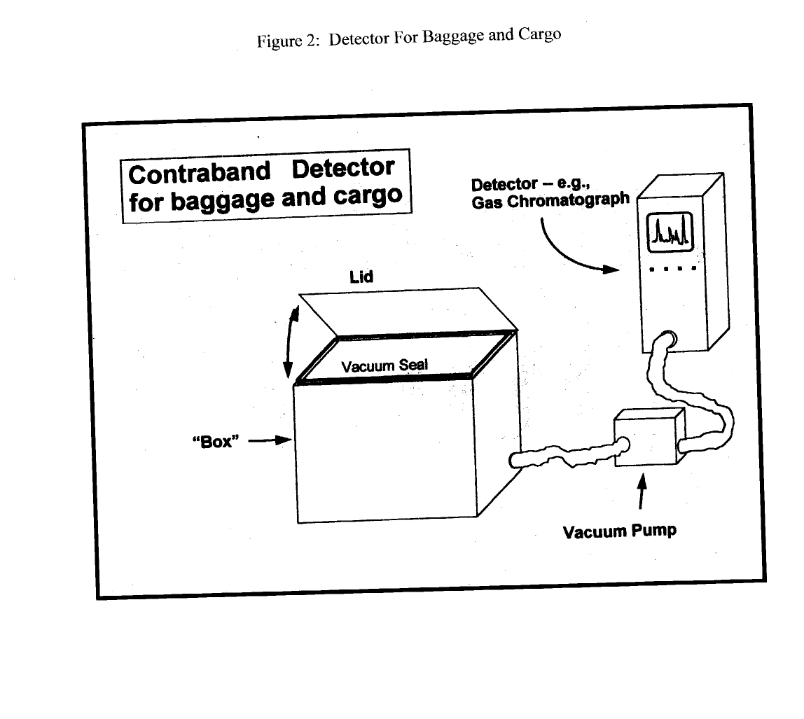

The vacuum pump is large enough in capacity so as to provide for quick, timely scanning. The pipes connecting the vacuum pump and detector are as small and short as possible to reduce the volume of air that must be passed to the detector, minimizing the time involved in each scan. The chamber can be configured with sliding doors on the ends of the chamber as shown in FIG. 1 or with an opening top as shown in FIG. 2.

Large cargo pallets, if tested en-mass, require a correspondingly large chamber. A large chamber for cargo pallets is provided with hoses placed throughout the pallet to assure that air samples from all areas of the cargo pallet are collected for testing as the pressure is reduced.

Also, to minimize the delay of vacuum scanning, several items can be placed in a large chamber at once. Also, one or more non-opening walls of the chamber are attached to bellows with a movable face allowing it to close in around the object being examined so as to minimize the volume of air that is de-pressurized and passed through to the detector, further minimizing the time required to examine the baggage.

A portable detector operating without a sealed vacuum chamber uses a hose attached to the vacuum pump which is then connected to the detector for scanning the person of a passenger, similar to the hand held metal detectors now used.

a portable detector operating without a sealed vacuum chamber uses a hose attached to the vacuum pump which is then connected to the detector for scanning the person of a passenger, similar to the hand held metal detectors now used.

What I claim as an invention is:

1. A contraband detector system comprising:
(a) a public transportation system;
(b) items transported on public transportation systems;
(c) a chamber capable of withstanding several atmospheres of external pressure;
(d) a mechanism for moving to and into the chamber transported items;
(e) a vacuum pump;
(f) means to examine the output of the vacuum pump;
(g) means to display the results of the examination; and
(h) mechanism for moving out of and away from the chamber items which have been examined.

2. The contraband detector system according to claim 1 wherein the chamber is selected from the group consisting of chambers large enough to hold (i) items carried by individual passengers, (ii) items checked by passengers as baggage, and (iii) items carried by the transportation system as cargo.

3. The contraband detector system according to claim 2 wherein means of transferring to and into the chamber items scheduled to be transported via the public transportation system comprises mechanisms selected from the group consisting of (i) conveyor belts, (ii) dollies, (iii) carts, (iv) cranes, (v) cargo handlers and (vi) baggage handlers.

4. The contraband detector system according to claim 3 wherein (a) means for opening the chamber permits the items to be placed into the chamber is a at least one item selected from the group consisting of (i) a moveable panel on a surface of the chamber, (ii) sliding door, (iii) a swing door, (iv) a lid or (v) resealable opening in the chamber, (b) means for resealing the chamber once it contains the items to be examined by the system by closing the panel, (c) means for gaining access to the air in the sealed chamber, (d) means for removing air from the resealed chamber, and (e) means for moving the removed air from the chamber to the means of examining the removed air for contraband substances.

5. The contraband detector system according to claim 4 wherein means for gaining access to the air in the sealed chamber is an opening in a surface of the chamber, means for removing air from the chamber is a mechanical pump, means for monitoring operation of the pump is a pressure gauge, means for controlling the action of the pump is a first switch connected to an external power supply, means for moving the air from the chamber to the pump is a first tube running from and out of the opening in the chamber to and into the intake of the pump and second tube from and out of the output of the pump to and into the intake of the of the means of examining the removed air for contraband substances.

6. The contraband detector system according to claim 5 wherein means for examining the removed air for contraband substances is a detector or detectors selected from the group consisting of (i) gas chromatographs, (ii) ion mobility spectroscopy, (iii) mass spectrometers or other detectors having the ability to detect and identify quickly elements, chemicals and compounds at trace levels.

7. The contraband detector system according to claim 6 wherein the detector providing the means to examine air from the chamber includes means to specify the elements, chemicals and compounds identified as contraband, containing or likely to contain contraband.

8. The contraband detector system according to claim 7 wherein the detector providing the means to examine air from the chamber includes means to vary threshold levels for positive findings of contraband and includes means to adjust the confidence level of its results by adjusting the threshold levels for each type of contraband.

9. The contraband detector system according to claim 8 where the means to display the results of the examination conducted by the detectors includes a screen, lights and audible alarms.

10. The contraband detector system according to claim 4 the means for removing air from the chamber uses at least three small, unattached tubes added with the items to be examined and running internally in the chamber from near the opening in the surface of the chamber connected to the first tube to portions of the chamber which are most remote to the opening.

11. The contraband detector system according to claim 2 wherein means of transferring from and out of the chamber items which have been examined comprises mechanisms selected from the group consisting of (i) conveyor belts, (ii) dollies, (iii) carts, (iv) cranes, (v) cargo handlers and (vi) baggage handlers.
